(19) United States
(12) Patent Application Publication
(10) Pub. No.: US 2014/0054277 A1
(43) Pub. Date: Feb. 27, 2014

(54) WIRE BONDING APPARATUS AND WIRE BONDING METHOD

(71) Applicant: KAIJO CORPORATION, Hamura-shi, Tokyo (JP)

(72) Inventor: Akio Sugito, Tokyo (JP)

(73) Assignee: KAIJO CORPORATION, Hamura-shi, Tokyo (JP)

(21) Appl. No.: 14/110,693

(22) PCT Filed: Oct. 3, 2012
(86) PCT No.: PCT/JP2012/075630

§ 371 Date: Oct. 8, 2013

(30) Foreign Application Priority Data
Dec. 27, 2011 (JP) 2011-285197

(51) Int. Cl. B23K 9/00

(52) U.S. Cl. CPC B23K 9/0008
USPC 219/136

(57) ABSTRACT

Improvement of productivity and product quality is achieved by improving bonding properties and reducing adverse effects caused by heating by supplying heated gaseous matter or gas to a limited area and during a limited period required for bonding. A nozzle-shaped casing including a heater formed of a metal having a large coefficient of resistance temperature which can be heated instantaneously in the interior thereof, an outlet port for blowing out hot gaseous matter from a distal end thereof to a bonding member including the bonding point, and an inlet port for allowing entry of compressed gaseous matter into the other end; heat control means configured to heat the heater; and compressed gaseous matter supply control means configured to perform supply and block of the compressed gaseous matter into the casing are provided, and the heat control means and the compressed gaseous matter supply control means control to provide a period in which the hot gaseous matter is not supplied from the casing to the bonding member in at least any one of periods when a bonding tool is not landed on the bonding point during the bonding operation by varying the temperature of the hot gaseous matter and blowing timing of the hot gaseous matter for each of the bonding points.

### TECHNICAL FIELD

The present invention relates to a wire bonding apparatus and a wire bonding method and, more specifically, to a wire bonding apparatus and a wire bonding method capable of performing stable wire bonding.

### BACKGROUND ART

In the related art, examples of a known wire bonding apparatus as illustrated in FIG. 8 include a bonding apparatus configured to connect a pad on an IC chip and an external lead. FIG. 8 is a drawing illustrating a configuration of a wire bonding apparatus of the related art.

As illustrated in FIG. 8, a wire bonding apparatus 30 of the related art is provided with a bonding head 31 including an ultrasonic horn 33 having a capillary 34 as a bonding tool 34 provided with an ultrasonic transducer (not illustrated) and mounted on a distal end, a bonding arm 32 having the ultrasonic horn 33 at one of distal ends and coupled to a supporting shaft 36 at the other end thereof, an encoder 35 as position detecting means configured to detect the position of the capillary 34 mounted on the distal end of the bonding arm 32, and a linear motor 37 configured to drive the bonding arm 32 upward and downward about the supporting shaft 36; an XY stage 40 as positioning means having the bonding head 31 mounted thereon and configured to position by moving two-dimensionally in an X-direction and/or a Y-direction; a bonding stage 43 having a lead frame on which an IC chip 60 or the like is mounted and configured to perform a bonding work by the capillary 34; a heater block 45 provided below the bonding stage 43 and configured to heat a lead frame or the like on the bonding stage 43; a control unit 50 including a microprocessor; and a drive unit 55 configured to emit drive signals to the bonding head 31 an the XY stage 40 in response to a command signal from the control unit 50. A camera 38 as image pickup means configured to take an image of a surface of a bonded component before starting bonding and detect positional displacement of the IC chip 60 and a lead 61 is mounted on the bonding head 31 of the wire bonding apparatus 30.

In wire bonding for connecting the pad of the IC chip and the external lead with a wire containing gold, silver, or copper as principal component on the bonding stage 43, a lead frame is placed on a heater plate 46 heated by a heater block 45 having a heater 45a integrated therein, ultrasonic vibrations and a load of the capillary 34 caused by the ultrasonic horn 33 is applied to the pad of the IC chip and the lead to achieve bonding with respect to the wire in a state in which the IC chip 60 and the lead 61 on the lead frame are heated.

However, in heating by the heater block 45, since heat is transmitted from the heater plate 46, a substrate (lead frame), to the chip in this sequence, heat conduction is not good depending on the types or the materials (ceramic, resin, and the like) of the substrate, so that heating to the IC chip takes time and cooling time is also required before feeding to the next step.

Depending on paste and an adhesive agent for fixing the IC chip on the substrate (lead frame) or on the types of the substrate (ceramic, resin, and the like), sufficient heating cannot be achieved in order to avoid change of properties or deformation due to heat and, as a result of depending excessively on the ultrasonic vibrations for securing the bonding property, stable bonding quality might not be obtained.

There is a case where an LED or a chip of a power semiconductor is adhered to a lead frame having a heat sink. In such a lead frame, since heat loss from the heat sink occurs, it takes time for heating with the heater block 45 and the heater plate 46 on the bonding stage 43, and hence the number of products to be produced may be reduced. Furthermore, when a large-sized substrate is bonded, the entire substrate needs to be heated even though the area to be bonded is small. Therefore, not only that the electricity is wasted, but also it takes significant time for heating and cooling before and after the bonding, and hence the productivity is lowered. Although heating is required only at the moment of bonding, the bonding stage 43 and the heater block 45 need to be continuously heated during the operation of the wire bonding apparatus, and hence electricity is consumed wastefully.

The ultrasonic horn 33 is formed of a metal, and is positioned above the bonding stage 43 which is heated by the heater block 45. Therefore, the position of the bonding tool to be held by the ultrasonic horn 33 is changed by thermal expansion caused by heating, and hence the accuracy of bonding position is lowered. Furthermore, the vibration characteristic of the ultrasonic horn 33 is changed by the metal expansion, and hence the amplitude of the ultrasonic vibration is changed, which may result in lowering of the bonding quality.

Since the camera 38 mounted on the bonding head 31 and configured to detect the position of the IC chip or the like is positioned above the bonding stage 43 which is heated by the heater block 45, the accuracy of position detection of the IC chip or the like due to the thermal expansion caused by heating is lowered. Furthermore, the accuracy of the position detection is lowered also by wavering of air between the IC chip and a lens due to heat. The lowering of the accuracy of the position detection may finally lead to the lowering of the accuracy of the bonding position.

In the bonding to a copper frame, the entire bonding stage needs to be maintained in an inert or reducing atmosphere in order to prevent oxidation of the surface of the copper frame caused by heating at the time of bonding.

The surface of a copper wire is oxidized while it is stored. In copper ball bonding, formation of a ball by using electric discharge is performed in the reducing atmosphere. Therefore, the surface of the copper ball to be bonded in a first bonding operation is not oxidized. However, in a second bonding operation, the bonding strength may be lowered due to the oxidization of the surface of the copper wire.

Furthermore, since the substrate (lead frame) is heated entirely on the bonding stage 43, paste and an adhesive agent used for bonding the IC chip to the substrate (lead frame) or chemical substances contained in the substrate is transformed into gas by heat and dispersed in air, so that peripheral mechanism components such as the ultrasonic horn 33, the bonding head 31, the camera 38, the XY stage 40, and a substrate fixing jig or the like on the bonding stage 43 are contaminated, whereby the function of the apparatus may be impaired.

Therefore, the bonding member having a low coefficient of thermal conductivity, for example, in the bonding of a large hybrid substrate or the like having a plurality of IC chips mounted thereon, heating of the IC chips on the pad cannot be performed sufficiently. Therefore, in order to improve this point, a wire bonding apparatus configured to irradiate a thermal beam from above the bonding surface and heat the bonding surface directly is disclosed in Patent Literature 1.

A wire bonding apparatus including heat control means configured to supply hot air to the surface of a semiconductor chip and a mounted member and heat the connected portion; and cooling means configured to supply cold air to the surface of the semiconductor chip and the mounted member to cool the connected portion, wherein the heat control means perform heating for a predetermined time before starting bonding and the bonding is performed after the heating has terminated, and the cooling means performs forced cooling after the bonding has terminated is disclosed in Patent Literature 2.

### CITATION LIST

### Patent Literatures

PTL1 JP-A-10-125712

PTL2 JP-A-2001-110840

### SUMMARY OF INVENTION

### Technical Problem

In recent years, when bonding a stacked package, an IC chip on a first stage is bonded, then the package is brought back to a previous process step once to stack an IC chip on the second stage, and the package is returned back to the wire bonding apparatus again to bond a new IC chip on the second stage. By repeating this process, the bonding of the IC chips stacked in multistage is performed. At this time, the lower the stage of the chip, the more thermal history associated with bonding is accumulated. Consequently, lowering of the product quality may result. The higher the stage of the chip, the harder the heat from the bonding stage is transferred. Therefore, the bonding temperature is lowered, and securement of the bonding strength becomes difficult. In the case of the IC chip protruded into air, heat is dissipated into air, and hence the bonding strength may further be lowered.

There is an LSI chip including several hundred or more pads (electrodes). In the LSI chip of this configuration, the pads bonded in the early stage are being heated even after having been bonded until bonding of all of the pads is terminated. In contrast, the last pad, being discharged from the bonding stage immediately after the bonding, is heated for a shorter time after the bonding. In the pads after bonding, bonding with the ball advances further by heat even after having been bonded. Therefore, in the same LSI chip, the bonding strength such as peel strength may be significantly different between the pads bonded in the early stage and the pads bonded in the final stage. This appears as an increase in standard deviation in measurement of the peeling strength, and lowering of process capability index Cpk results. In order to compensate the lowering of the process capability index Cpk, securement of the bonding strength more than necessary is required, and setting (adjustment) of bonding conditions becomes difficult.

Between the pad on the IC chip side and the lead on the substrate (lead frame) side, the material and the shape thereof are significantly different, and the bonding conditions such as a load and ultrasonic vibration strength are significantly different in many cases as well. However, in a current system in which the bonding stage is entirely heated, the pad of the IC chip subjected to the first bonding operation and the lead of the lead frame subjected to the second bonding operation are heated to the same temperature on the heater plate, and hence optimal temperatures cannot be set at a first bonding point (pad) and a second bonding point (pad), respectively.

The wire bonding apparatus of Patent Literature 1 employs both heating by the heater plate of the related art positioned on the backside of the substrate and direct heating of the bonding surface by irradiating the thermal beam from above the bonding surface. When the coefficient of thermal conduction of members such as an HIC substrate is low, a heating effect may be expected. However, in a case where a heating state continues for a long time like the bonding of the stacked package or the bonding of a multiple-pin lead frame, unevenness of the bonding strength may occur.

In the wire bonding apparatus disclosed in Patent Literature 2, the bonding is performed after the heating has terminated, and the forced cooling is performed by the cooling means after the bonding has terminated. Therefore, the cooling time in the next step is not necessary, and hence the in-process loss may be reduced. However, since the surfaces of the semiconductor chip and the mounted members are heated uniformly before bonding, optimal temperatures may not be set at the first bonding point (pad) and the second bonding point (pad), respectively.

Accordingly, it is an object of the invention to provide a wire bonding apparatus and a wire bonding method capable of not only improving bonding properties, but also reducing adverse effects in association with heating, and achieving improvement of both of the productivity and the product quality by heating a chip, a substrate (lead frame), a ball, a bonding tool, or a bonding wire by supplying heated air or gas from an extremely compact hot gaseous matter heater mounted on a bonding head or a bonding arm to a limited area and during a limited period required for bonding.

### Solution to Problem

In order to achieve the above-described object, there is provided a wire bonding apparatus of the present invention configured to connect an electrode (pad) on a semiconductor chip as a bonding point and an external terminal (lead) with a wire by a bonding tool, including: a nozzle-shaped casing including a heater formed of a metal having a large coefficient of resistance temperature which can be heated instantaneously in the interior thereof, an outlet port for blowing out hot gaseous matter from a distal end thereof to a bonding member including the bonding point, and an inlet port for allowing entry of compressed gaseous matter into the other end; heat control means configured to heat the heater; and compressed gaseous matter supply control means configured to perform supply and block of the compressed gaseous matter into the casing, wherein control is performed to provide a period in which the hot gaseous matter is not supplied from the casing to the bonding member in at least any one of periods when the bonding tool is not landed on the bonding point during the bonding operation.

The wire bonding apparatus of the invention is characterized in that the heat control means and the compressed gaseous matter supply control means are configured to vary the temperature of the hot gaseous matter and the blowing timing of the hot gaseous matter for each of the bonding points.

The wire bonding apparatus of the invention is also characterized in that the heat control means is configured to control a heat generating temperature of the heater without using a temperature sensor by controlling the value of resistance of the heater to maintain a predetermined value by electricity distribution.

In order to achieve the above-described object, there is provided a wire bonding apparatus of the present invention configured to connect an electrode (pad) on a semiconductor chip as a bonding point and an external terminal (lead) with a wire by a bonding tool, including: a nozzle-shaped casing including a heater formed of a metal having a large coefficient of resistance temperature which can be heated instantaneously in the interior thereof, an outlet port for blowing out hot gaseous matter from a distal end thereof to a bonding member including the bonding point, and an inlet port for allowing entry of compressed gaseous matter into the other end; heat control means configured to heat the heater; and compressed gaseous matter supply control means configured to perform supply and block of the compressed gaseous matter into the casing, wherein control is performed to provide a period in which the hot gaseous matter is not supplied from the casing to the bonding member by the heat control means and the compressed gaseous matter supply control means in at least any one of periods when the bonding tool is not landed on the bonding point during the bonding operation.

### Advantages and Effects of the Invention

According to the invention, an optimal heating may be performed only during a minimum time required for bonding by controlling to provide a period during which the hot gaseous matter is not provided in at least any one of periods when the bonding tool is not landed on the bonding point during the bonding operation.

Consequently, selective heating of only part contributing to the bonding such as the surface of the electrode, the bonding wire, and the distal end of the bonding tool is achieved while avoiding penetration of heat to the member or diffusion of the heat to the peripheral portion.

In addition, since the heating temperature may be variably set at each of the bonding points such as the first bonding point and the second bonding point, the bonding may be performed at an optimal heating temperature.

In the bonding of the stacked package, since the surface of the electrode can reliably be heated because the apparatus employs a top heating system, and the penetration of heat into the chip is suppressed because the apparatus employs an instantaneous heating system, so that the accumulation of the thermal history to the chip on the lower layer may be prevented.

In addition, since the heating control means is configured to control so that the value of resistance of the heater in the casing is maintained at the predetermined value by electricity distribution, control of the heat generating temperature of the heater is enabled without using the temperature sensor, and hence a sensor for detecting the temperature of the heater is not necessary, so that the configuration in the casing may be simplified.

### BRIEF DESCRIPTION OF DRAWINGS

FIG. 1 is a drawing illustrating a configuration of a bonding apparatus of the invention.

FIG. 2 is a drawing illustrating a configuration of a hot gaseous matter heater.

FIG. 3 is a drawing illustrating a configuration of a hot gaseous matter heater drive unit for driving the hot gaseous matter heater.

FIG. 4 is a circuit diagram illustrating a configuration of a heater drive circuit.

FIG. 5 is a timing chart illustrating an operation of the heater drive circuit.

FIG. 6 is a drawing illustrating timing of application of hot gaseous matter in bonding operation.

FIG. 7 is a flowchart illustrating control of the hot gaseous matter application in the bonding operation.

FIG. 8 is a drawing illustrating a configuration of a wire bonding apparatus of the related art.

### DESCRIPTION OF EMBODIMENTS

Referring now to the drawings, embodiments for implementing a wire bonding apparatus and a wire bonding method according to the invention will be described below. The invention is configured to be capable of improving bonding properties by supplying heated air or gas to a heating area required for bonding for a limited time by heating a chip, a substrate (lead frame), a ball, a bonding tool, or a bonding wire with gaseous matter such as heated air or gas from an extremely compact hot gaseous matter heater mounted on a bonding head or a bonding arm, alleviating adverse effect in association with heating by a heater plate of the related art, and achieving improvement of the productivity and the quality.

### Configuration of Bonding Apparatus

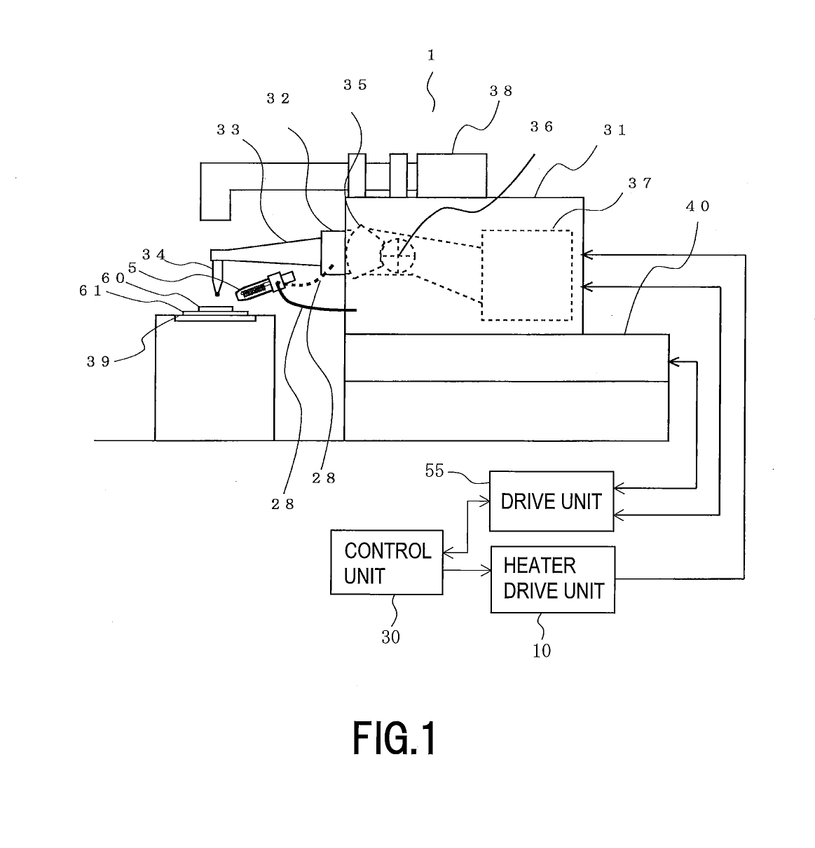

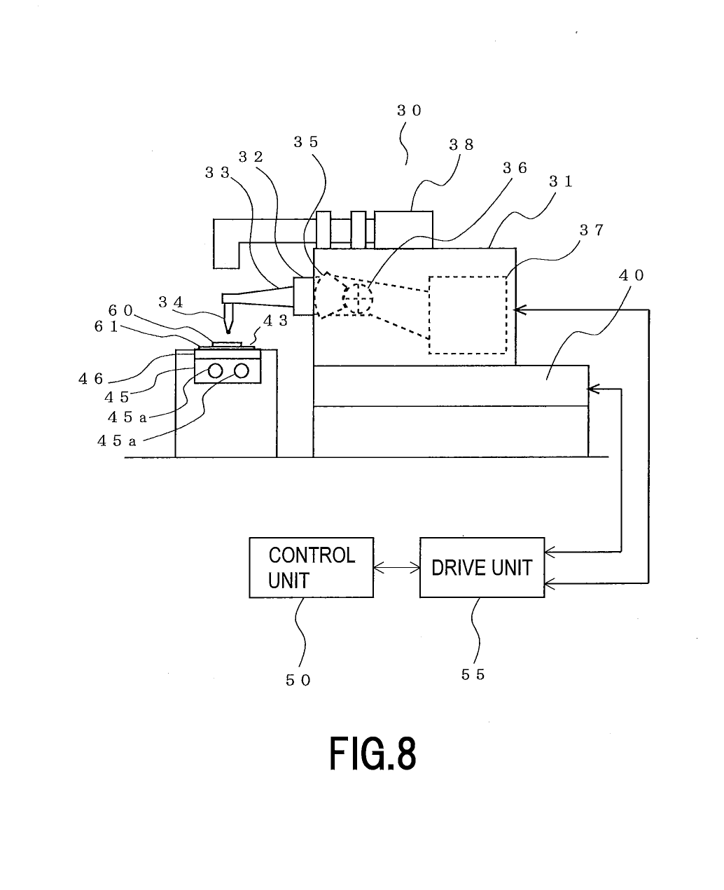

FIG. 1 is a drawing illustrating a configuration of a bonding apparatus of the invention. The same components as those of the configuration of a wire bonding apparatus of the related art illustrated in FIG. 8 are denoted by the same reference numerals, and detailed descriptions relating to the configurations thereof are omitted.

As illustrated in FIG. 1, a wire bonding apparatus 1 includes a bonding head 31, an XY stage 40 having the bonding head 31 mounted thereon and configured to be transferrable in a two-dimensional direction along an XY axis, a bonding stage 39 configured to place a lead frame on which an IC chip 60 as a bonded component is mounted, and a control unit 30 configured to perform control of the wire bonding apparatus 1. A hot gaseous matter heater 5 is mounted on the bonding head 31 and a bonding arm 32. The hot gaseous matter heater 5 is configured to supply heated air or gas to the IC chip, the substrate (lead frame), the ball, the bonding tool, or the bonding wire to heat these bonding members.

A microcomputer as the control unit 30 includes a program configured to perform control such as bonding operation of the wire bonding apparatus 1 integrated therein, and the microcomputer is configured to perform control of various operations including an operation of the hot gaseous matter heater 5 of the wire bonding apparatus 1 by executing the program.

### Configuration of Hot Gaseous Matter Heater

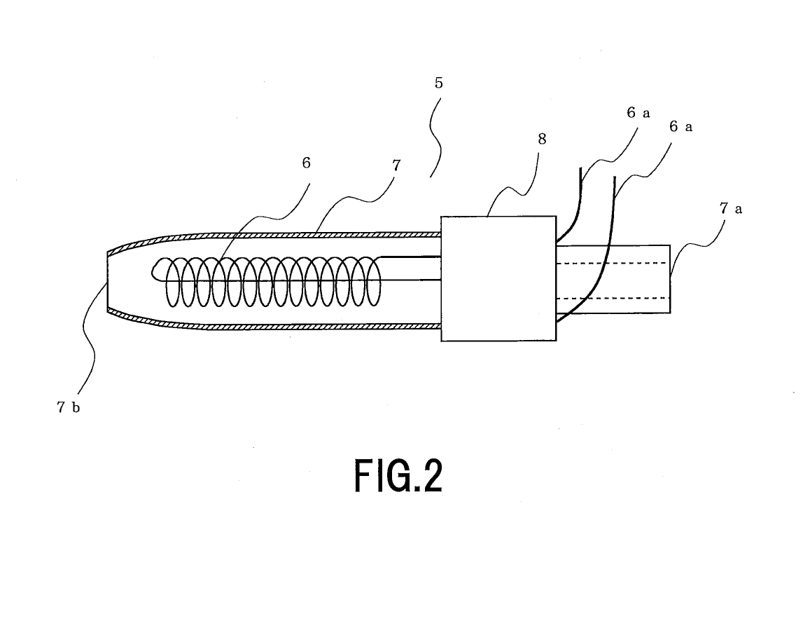

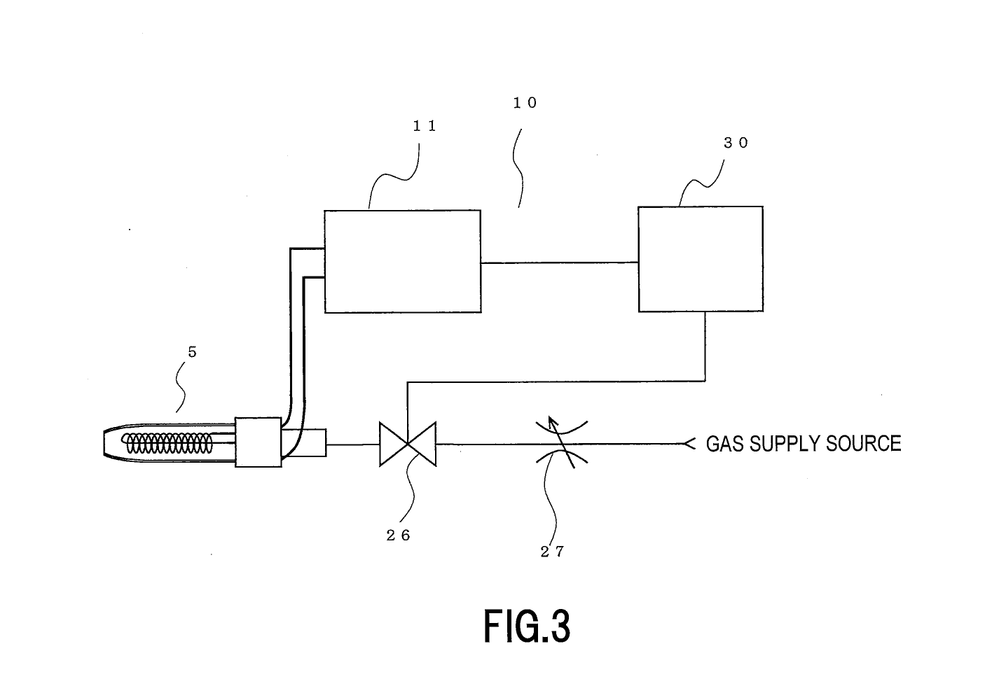

FIG. 2 is a drawing illustrating a configuration of a hot gaseous matter heater. As illustrated in FIG. 2, the hot gaseous matter heater 5 includes a casing 7, a heat-generating member (heater) 6 integrated in the casing 7, and a supporting member 8 provided on an outer periphery of the casing 7. The casing 7 includes a hot gaseous matter outlet port 7b formed into a nozzle shape and configured to blow out gaseous matter such as heated high-pressure air or gas from a distal end thereof and a gaseous matter inlet port 7a configured to allow entry of the high-pressure gaseous matter at the other end. The heat-generating member (heater) 6 includes a coil-shaped heater 6, and the heater 6 is preferably a member having a large coefficient of resistance temperature and being stable in coefficient of resistance temperature in repetition of heating. White gold is preferable as a material of the heat-generating member (heater) 6. Both ends of the heater 6 are connected to a lead wire 6a, and a current from an external heater drive circuit (illustrated in FIG. 3) is flowed to the lead wire 6a to heat the heater 6 by Joule heat. The hot gaseous matter heater 5 is configured to heat the gaseous matter supplied from the gaseous matter inlet port 7a by the heater 6, and blow out the heated gaseous matter from the hot gaseous matter outlet port 7b at a distal end of the nozzle-shaped casing 7.

A supporting member 8 provided on the outer periphery of the casing 7 is configured to mount the hot gaseous matter heater 5 on the bonding head 31 or the bonding arm 32, and is mounted via a mounting bracket 28 so that the hot gaseous matter outlet port 7b is positioned in the direction of a pad of the IC chip as a bonding point, a lead of the substrate (lead frame), the ball at a distal end of the bonding tool, or the bonding wire.

When the hot gaseous matter heater 5 is mounted on the bonding head 31 by using the mounting bracket, the hot gaseous matter heater 5 always moves integrally with the bonding head 31 by the XY stage. If a target position of the hot gaseous matter blowing out from the hot gaseous matter heater 5 is adjusted to a landing point of the bonding tool, the IC chip, the substrate (lead frame), the ball, and the bonding tool may be heated at the time of bonding by supplying hot gaseous matter with timing of bonding.

When the hot gaseous matter heater 5 is mounted on the bonding arm 32 by using the mounting bracket, the hot gaseous matter heater not only moves integrally with the bonding head 31 by the XY stage, but also moves upward and downward together with the bonding arm 32. If the target position of the hot gaseous matter blowing out from the hot gaseous matter heater 5 is adjusted to near a distal end of a bonding tool 34, the IC chip, the substrate (lead frame), the ball, and the bonding tool may be heated at the time of bonding by supplying hot gaseous matter with timing of bonding. In this case, a stress in association with shaping of the wire may be reduced by further heating and softening the bonding wire by hot gaseous matter at the time of looping operation.

### Configuration of Hot Gaseous Matter Heater Drive Unit

FIG. 3 is a drawing illustrating a configuration of a hot gaseous matter heater drive unit for driving the hot gaseous matter heater. As illustrated in FIG. 3, a hot gaseous matter heater drive unit 10 includes a heater drive circuit 11 configured to distribute electricity to the filament 6 of the hot gaseous matter heater 5, an electromagnetic opening and closing valve 26 inserted into piping that supplies the gaseous matter to the gaseous matter inlet port 7a of the hot gaseous matter heater 5, and a movable throttle valve 27 between the electromagnetic opening and closing valve 26 and a gas supply source. The heater drive circuit 11 and the electromagnetic opening and closing valve 26 are connected to a wire bonding apparatus 30, and electricity distribution control to the filament 6 of the hot gaseous matter heater 5, and supply and block of the gas to the hot gaseous matter heater 5 are performed by the control unit. The heater drive circuit 11 is configured to control a value of resistance of the heater to maintain a predetermined value by the distribution of electricity and control a heat generating temperature of the filament 6 of the hot gaseous matter heater 5 without using a temperature sensor. Accordingly, ON/OFF of heater current and data setting or the like of the set temperature are performed in accordance with the bonding operation under the control from the control unit 30. The electromagnetic opening and closing valve 26 is inserted into the piping of gas to the hot gaseous matter heater 5, and opening and closing of supply of gas or the like in accordance with the bonding operation is performed by the control unit 30 of the wire bonding apparatus 1. In order to avoid an influence of gas or useless heating during the bonding operation, the electromagnetic opening and closing valve 26 having high opening and closing response speed (preferably 1 ms or slower) is preferable. In order to reduce delay of response of a gas pressure, piping of the hot gaseous matter heater 5 and the electromagnetic opening and closing valve 26 is set to be as short as possible. The movable throttle valve 27 is provided between the electromagnetic opening and closing valve 26 and the gas supply source to maintain an adequate gas flow rate. The gaseous matter supplied to the gaseous matter inlet port 7a of the hot gaseous matter heater 5 is air or inert gas, and heated air or inert gas is discharged from the hot gaseous matter outlet port 7b of the hot gaseous matter heater 5.

### Configuration of Heater Drive Circuit

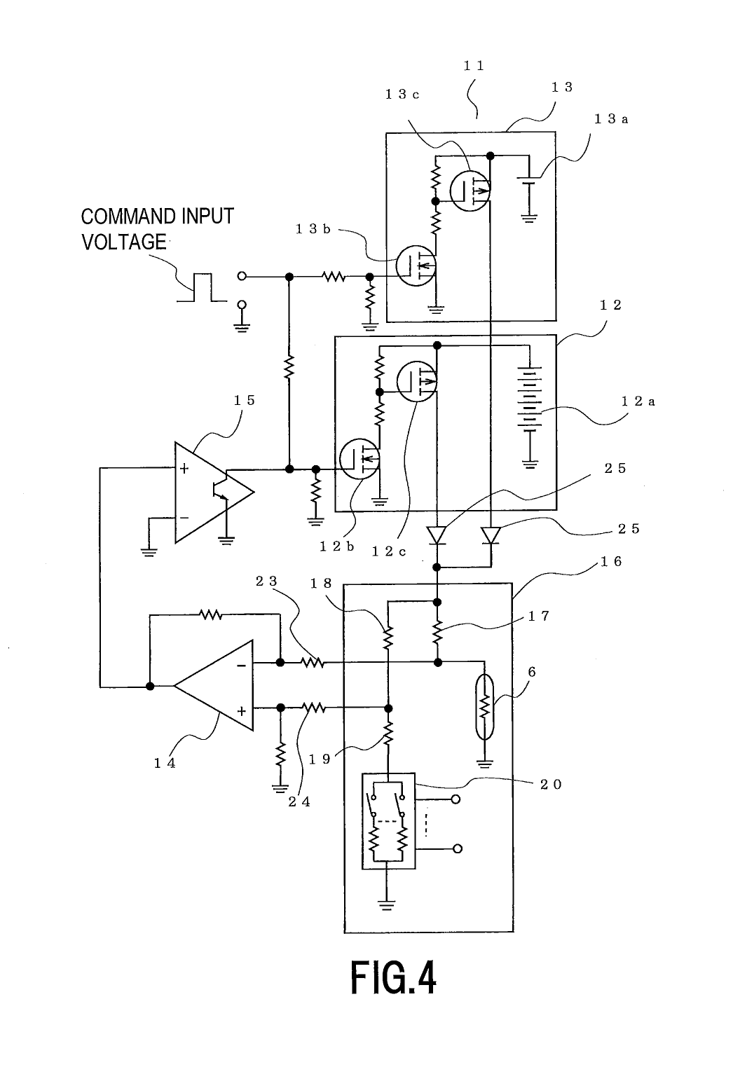

Subsequently, with reference to FIG. 4, a configuration of the heater drive circuit will be described. As illustrated in FIG. 4, the heater drive circuit 11 includes a bridge circuit 16, a differential amplifier 14, a comparator 15, a high-voltage drive circuit 12, and a low-voltage drive circuit 13.

The bridge circuit 16 is composed of a resistance resistance 17 (a value of resistance is R1) connected in series, and the filament heater 6 (filament is formed of white gold having a positive coefficient of resistance temperature and has a value of resistance of Rh), a resistance 18 (a value of resistance is R2) connected in series, a resistance 19 (a value of resistance is R3), and a digital potentiometer 20 (a selected value of resistance is VR1). The digital potentiometer 20 includes a plurality of resistances integrated therein, and is configured to output a figure corresponding to the value of resistance from the external control unit 30 and specify a specific value of resistance.

A connecting point between the resistance 17 and the heater 6 is input to a − (minus) terminal of the differential amplifier 14 via a resistance 23, and a connecting point between the resistance 18 and the resistance 19 is input to a + (plus) terminal of the differential amplifier 14 via a resistance 24. An output from the differential amplifier 14 is input to a + (plus) terminal of the comparator 15. A − (minus) terminal of the comparator 15 is connected to GND. An output from the comparator 15 is of a general open collector type of an NPN transistor, and when the output from the comparator 15 is at a high level, the high-voltage drive circuit 12 and the low-voltage drive circuit 13 are configured to be turned ON by a pull-up voltage of a command input voltage as a control signal. In this manner, the output from the comparator 15 functions as a signal configured to control the high-voltage drive circuit 12 and the low-voltage drive circuit 13 when the control signal is input.

The heater drive circuit 11 is provided with the high-voltage drive circuit 12 and the low-voltage drive circuit 13, and the high-voltage drive circuit 12 controls a high-voltage power source 12a by FETs 12b and 12c and applies the high-voltage power source 12a to the bridge circuit 16. The low-voltage drive circuit 13 is configured to control a low-voltage power source 13a by FETs 13b and 13c and apply the low-voltage power source 13a to the bridge circuit 16.

Power sources of the high-voltage drive circuit 12 and the low-voltage drive circuit 13 are both connected to the bridge circuit 16 including the heater 6, and a protective diode 25 is inserted in series in the forward direction in order to prevent a reverse voltage to the respective circuits.

By passing a current to the heater 6 of the hot gaseous matter heater 5, the heater 6 is heated by generated Joule heat and the temperature is increased. The heater 6 is increased in temperature and the value of resistance of the heater 6 by itself is also increased. Since the relationship between the value of resistance and the temperature of the heater 6 is linear, the temperature of the heater 6 may be set to be constant by maintaining the value of resistance of the heater 6 constant. When setting the temperature of the surface of the heater 6 to be high, a value of resistance of the digital potentiometer 20 is selected so that the value of resistance of the heater 6 is increased.

The heater drive circuit 11 is configured to control the heat generating temperature of the heater by controlling the value of resistance of the heater integrated in the bridge circuit 16 to be maintained at a predetermined value. The control of the value of resistance of the heater 6 detects the voltage difference of the contact point of the bridge circuit 16 by the differential amplifier 14, and distribute high voltage from the high-voltage drive circuit 12 to the bridge circuit 16 so that the voltage difference detected by the differential amplifier 14 becomes zero. Accordingly, the value of resistance of the heater 6 is maintained to a predetermined value, and the heat generating temperature of the heater 6 is maintained to be constant.

### Operation of Heater Drive Circuit

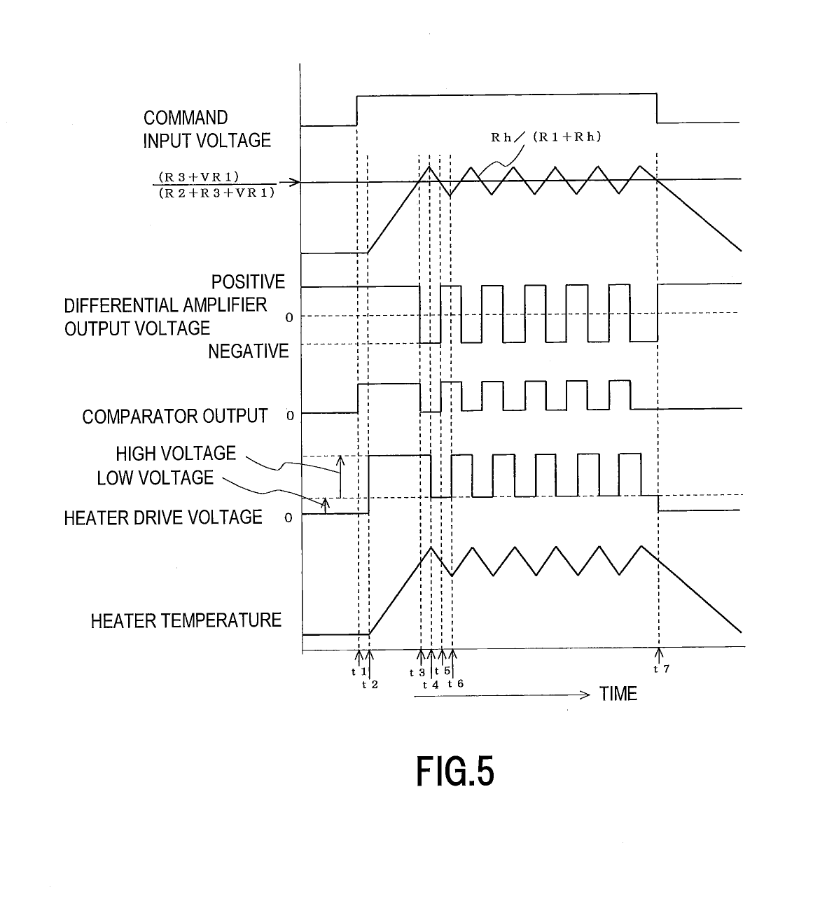

FIG. 5 is a timing chart illustrating an operation of the heater drive circuit. Waveforms illustrated in FIG. 5 show, from the top in sequence, a waveform of a command voltage input, a drawing illustrating a change of a ratio of the resistance of the heater input to a differential amplifier, a waveform of a differential amplifier output voltage, a waveform of an output from a comparator, a waveform of a heater drive voltage, and a waveform of a heater temperature, respectively.

As illustrated in FIG. 5, the command input voltage is output from the control unit 30 to an input terminal of the heater drive circuit 11 at a time t1. At this time, the output from the comparator 15 is a high-level signal, then the high-voltage drive circuit 12 and the low-voltage drive circuit 13 are driven, and a high voltage and a low voltage are applied to the bridge circuit 16. Accordingly, the current flows to the heater 6 and the heater temperature is increased, and the value of resistance Rh of the heater is increased. At this time, assuming that the voltage applied to the bridge circuit is V, a voltage difference between a voltage Vin1 generated at the heater 6 and a voltage Vin2 at the connecting point between the resistance 18 and the resistance 19 in the bridge circuit 16 is amplified to a voltage by the differential amplifier 14, and is input to the comparator 15. When Vin2>Vin1 is satisfied, that is, when V (R3+VR1)/(R2+R3+VR1)>V·Rh/(R1+Rh), the differential amplifier 14 becomes a positive output voltage and is input to the + (plus) terminal of the comparator 15. At this time, a pull-up voltage is output from the comparator 15, and the high-voltage drive circuit 12 and the low-voltage drive circuit 13 are turned On by the pull-up voltage output from the comparator 15 (during a period from t2 to t4).

The high-voltage drive circuit 12 has a configuration of a high-side switch using a P-channel MOS for an output. An N-channel MOS is used for the gate drive of the output P-channel MOS for the purpose of achieving a quicker response. When the high-voltage power source is turned ON by the high-voltage drive circuit 12, a high voltage is applied to the bridge circuit 16 including the heater 6, and current flows to the heater 6, whereby heat is generated by Joule heat. The voltage of the high-voltage power source 12a of the high-voltage drive circuit 12 is set to allow a current as high as several times the rating, preferably, as high as dozens of times the rating to flow to the heater 6 by turning the high-voltage drive circuit 12 ON. Accordingly, as illustrated in FIG. 5, the heater temperature is increased abruptly, and the value of resistance Rh of the heater 6 is also increased.

In contrast, when the heater 6 abruptly generates heat and the temperature is increased and also the value of resistance of the heater 6 is increased, and consequently a voltage difference at the differential amplifier 14 between the voltage Vin1 generated in the heater 6 and the voltage Vin2 at the connecting point between the resistance 18 and the resistance 19 in the bridge circuit 16 is Vin2<Vin1, that is, (R3+VR1)/(R2+R3+VR1)<Rh/(R1+Rh) is satisfied, the differential amplifier 14 outputs a negative voltage (during a period from t3 to t5) and the output from the comparator 15 is in a low level. Therefore, the high-voltage drive circuit 12 is turned OFF. Accordingly, the heat generation of the heater 6 is stopped and the temperature of the heater 6 is lowered, so that the value of resistance of the heater 6 is reduced. While the heater drive circuit 11 is operated (while the command input voltage is in the ON state), a minimum required voltage is applied to the bridge circuit including the heater 6 in order to maintain an output voltage from the differential amplifier 14. The voltage applied to the bridge circuit 16 is set to be sufficiently low so that the heater 6 does not increase in temperature beyond the set temperature, and is supplied by the low-voltage drive circuit 13. The reason is that if the voltage is not applied to the bridge circuit 16 including the heater 6, the output voltage from the differential amplifier 14 becomes zero irrespective of the resistance of the heater 6, that is, the temperature, and hence the temperature control is prevented from becoming disabled. The low-voltage drive circuit 13 has a configuration of the high-side switch with the P-channel MOS which is similar to the high-voltage drive circuit 12, and turns the low-voltage power source 13a ON while the command voltage input is in the high level.

From then onward, while the command voltage input is in the high level, the magnitudes of the voltage Vin1 generated at the heater 6 and the voltage Vin2 at the connecting point between the resistance 18 and the resistance 19 in the bridge circuit 16 at the differential amplifier 14 is switched alternately, and ON/OFF control of the high-voltage drive circuit 12 is repeated.

### Bonding Operation

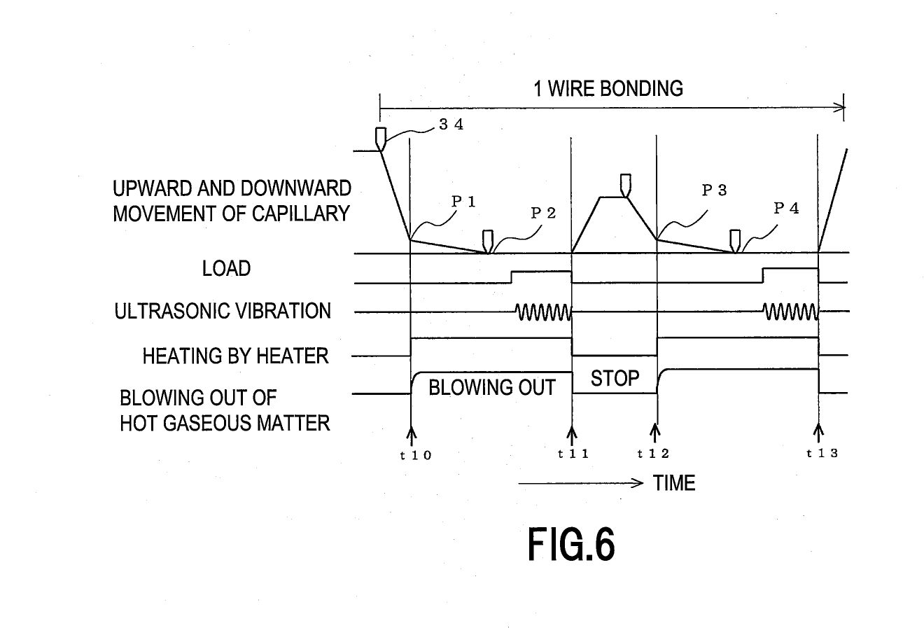

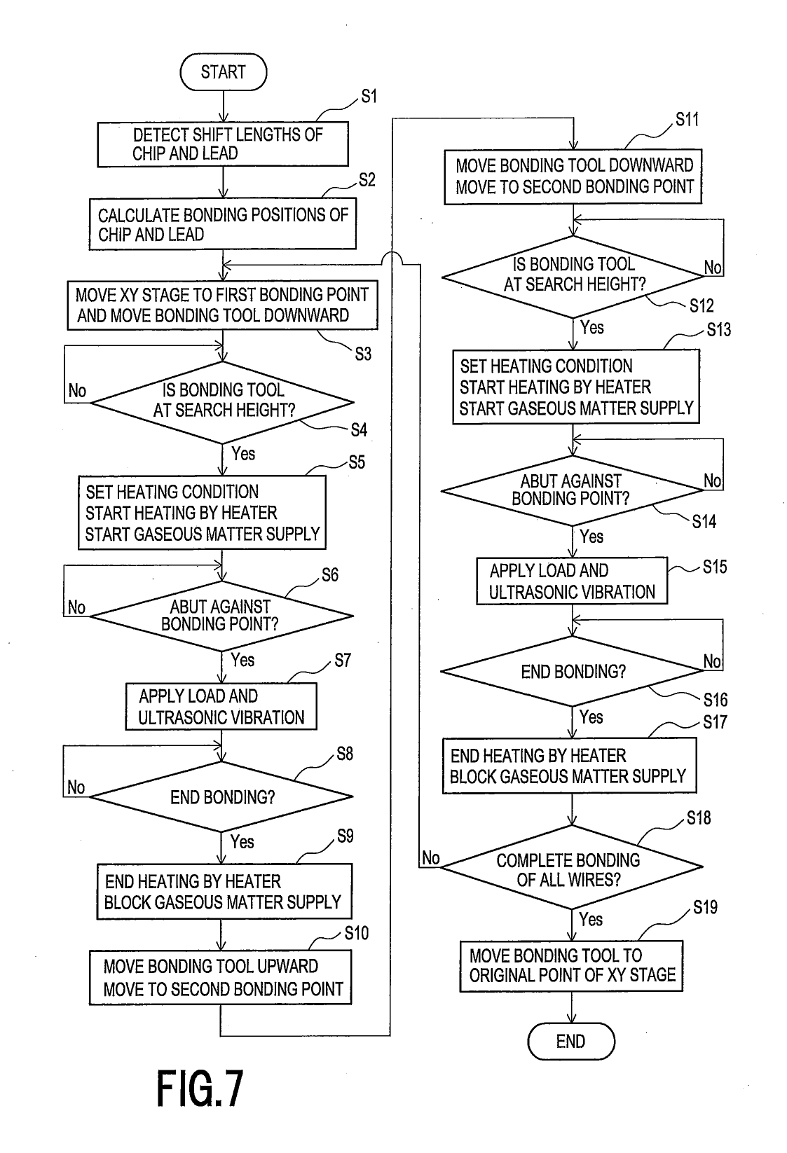

Subsequently, the bonding operation in the wire bonding apparatus configured as described above will be described with reference to FIG. 6 and FIG. 7. FIG. 6 is a drawing illustrating timing of application of hot gaseous matter in the bonding operation, and FIG. 7 is a flowchart illustrating the control of the hot gaseous matter application in the bonding operation. The operation given below is performed by executing a program integrated in a memory of the microcomputer in the control unit. Bonded components are assumed to be carried by a carrying apparatus (not illustrated), and be positioned in the bonding stage 39.

First of all, as illustrated in FIG. 7, detection of a shift length between the IC chip and the lead is performed (Step S1). Subsequently, calculation of the bonding position between the IC chip and the lead is performed from the detected shift length between the IC chip and the lead (Step S2). Accordingly, the position of the pad of the IC chip as the first bonding point and the position of the lead as the second bonding point to be bonded are determined.

After the calculation of the bonding position has performed, the XY stage 40 having the bonding head 31 mounted thereon is moved to the first bonding position. The capillary 34 as the bonding tool 34 is controlled to be lowered to immediately above the first bonding point (Step S3).

After the lowering of a capillary 34 has started, whether or not the capillary 34 has reached a search height (the position of P1 at t10 illustrated in FIG. 6) is checked (Step S4). The term “search height” is a height of the capillary 34 when the lowering speed of the capillary 34 set in advance is changed from a high speed to a low speed. The capillary 34 is lowered at a high speed, and is reduced in speed before the search height and is lowered at a search speed, which is a constant speed lower than a search level S, so that the ball locked to a distal end of the capillary 34 comes into contact with the pad of the first bonding point. At the second bonding point, the wire fed out from the distal end of the capillary 34 comes into contact with the surface of the lead.

When the capillary 34 reaches the search height (Yes in Step S4), the capillary 34 is lowered at a search speed as a constant low speed and the heater drive unit 11 selects the value of resistance of the digital potentiometer 20, sets heating conditions such as the temperature of the hot gaseous matter heater 5, starts heating of the hot gaseous matter heater 5, and starts supply of gaseous matter to the gaseous matter inlet port 7a of the hot gaseous matter heater 5 (Step S5). Accordingly, hot gaseous matter is blown out from the hot gaseous matter outlet port 7b of the hot gaseous matter heater 5 and heats an area in the vicinity of the bonding point.

Subsequently, whether or not the ball locked to the distal end of the capillary 34 comes into contact with the pad at the first boding point is checked (Step S6). After the fact that the distal end of the capillary 34 comes into contact (P2 illustrated in FIG. 6) has confirmed (Yes in Step S6), a load and ultrasonic vibrations are applied to the capillary 34 (Step S7). Whether or not a predetermined application time of the load and the ultrasonic wave vibrations has elapsed after the load and the ultrasonic vibrations have been applied to the capillary 34 and the bonding has terminated is checked (Step S8). After the load and the ultrasonic wave vibrations have been applied to the capillary 34 at t11 illustrated in FIG. 6 for a predetermined time and the bonding has terminated (Yes in Step S8), heating of the hot gaseous matter heater 5 is terminated and supply of gaseous matter to the hot gaseous matter heater 5 is blocked by the electromagnetic opening and closing valve 26 (Step S9). Subsequently, the capillary 34 is moved upward to move the XY stage to the second bonding point (Step S10).

Subsequently, the capillary 34 is controlled to be lowered to immediately above the second bonding point (Step S11). Whether or not the capillary 34 reaches the search height (the position of P3 at t12 illustrated in FIG. 6) is checked (Step S12). After the capillary 34 has reached the search height (Yes in Step S12), the heater drive unit 11 selects the value of resistance of the digital potentiometer 20, sets heating conditions such as the temperature of the hot gaseous matter heater 5, starts heating of the hot gaseous matter heater 5, and starts supply of gaseous matter to the gaseous matter inlet port 7a of the hot gaseous matter heater (Step S13). Subsequently, whether or not the wire fed to the distal end of the capillary 34 comes into contact with the lead at the second boding point is checked (Step S14).

After the fact that the distal end of the capillary 34 comes into contact(P4 illustrated in FIG. 6) has confirmed, a load and ultrasonic vibrations are applied to the capillary 34 (Step S15). Whether or not a predetermined application time of the load and the ultrasonic wave vibrations has elapsed after the load and the ultrasonic vibrations have been applied to the capillary 34 and the bonding has terminated is checked (Step S16). After the bonding has terminated at t13 illustrated in FIG. 6, heating of the hot gaseous matter heater 5 is terminated and supply of gaseous matter to the hot gaseous matter heater 5 is blocked by the electromagnetic opening and closing valve 26 (Step S17).

Whether or not the bonding for all the wires is completed is checked (Step S18). When the bonding of all of the wires is not completed (No in Step S18), the capillary 34 is moved upward, the ball is formed at the distal end of the capillary 34, and then the procedure goes to Step S3 to continue the remaining bonding. In contrast, when the bonding of all the wires is completed (Yes in Step S18), the capillary 34, and the XY stage are moved to their original points and end the bonding operation is terminated (Step 19).

In this manner, the wire bonding apparatus of the invention is configured to control to provide a period during which hot gaseous matter is not supplied in at least any one of periods when the capillary 34 is not landed on the bonding point during the bonding operation. In the bonding operation illustrated in FIG. 6, the wire bonding apparatus controls so that the hot gaseous matter is not supplied during a period from the end of the bonding until reaching the search height at the next bonding point (a period from t11 to t12 illustrated in FIG. 6). The period when the hot gaseous matter is not supplied during the bonding operation is not limited and, for example, may be a period from the end of the bonding to the start of lowering of the capillary 34 at the next bonding point.

As described above, according to the invention, an optimal heating may be performed only during a minimum period required for bonding by controlling to provide a period in which the hot gaseous matter is not provided in at least any one of periods when the bonding tool is not landed on the bonding point during the bonding operation. Consequently, selective heating of only part contributing to the bonding such as the surface of the electrode, the bonding wire, and the distal end of the bonding tool is achieved while avoiding penetration of heat to the member or diffusion of the heat to the peripheral portion.

In addition, since the heating temperature may be variably set at each of the bonding points such as the first bonding point and the second bonding point, the bonding may be performed at an optimal heating temperature.

In the bonding of the stacked package, since the surface of the electrode may reliably be heated because the apparatus employs a top heating system, and the penetration of heat into the IC chip is suppressed because the apparatus employs an instantaneous heating system, the accumulation of the thermal history to the chip on the lower layer may be prevented.

In addition, since the heating control means is configured to control the value of resistance of the heater in the casing so as to be maintained at the predetermined value by electricity distribution, control of the heat generating temperature of the heater is enabled without using the temperature sensor, and hence a sensor for detecting the temperature of the heater is not necessary and hence the configuration in the casing may be simplified.

The invention may be embodied in various modes without departing the essential characteristics. Therefore, needless to say, the embodiment described above is given only for description and does not limit the invention.

### REFERENCE SIGNS LIST

1, 30 wire bonding apparatus

5 hot gaseous matter heater

6 heat-generating member (heater), filament (white gold)

6a lead wire

7 casing

7a gaseous matter inlet port

7b hot gaseous matter outlet port

8 Supporting member

10 hot gaseous matter heater drive unit

11 heater drive circuit

12 high-voltage drive circuit

12a high-voltage power source

12b, 12bc FET

13 low-voltage drive circuit

13a low-voltage power source

13b, 13c FET

14 differential amplifier

15 comparator

16 bridge circuit

17, 18, 19 resistance (for bridge circuit)

20 digital potentiometer

23, 24 resistance

25 diode

26 electromagnetic opening and closing valve

27 throttle valve

28 mounting bracket

31 bonding head

32 bonding arm

33 ultrasonic horn

34 bonding tool (capillary)

35 encoder

36 supporting shaft

37 rear motor

38 camera

39, 43 bonding stage

40 XY stage

45 heater block

45a heater

46 heater plate

30, 50 control unit

55 drive unit

60 IC chip

61 lead

1. A wire bonding apparatus configured to connect an electrode (pad) on a semiconductor chip as a bonding point and an external terminal (lead) with a wire by a bonding tool, comprising:
a nozzle-shaped casing including a heater formed of a metal having a large coefficient of resistance temperature which can be heated instantaneously in the interior thereof, an outlet port for blowing out hot gaseous matter from a distal end thereof to a bonding member including the bonding point, and an inlet port for allowing entry of compressed gaseous matter into the other end;
heat control means configured to heat the heater; and
compressed gaseous matter supply control means configured to perform supply and block of the compressed gaseous matter into the casing, wherein
control is performed to provide a period in which the hot gaseous matter is not supplied from the casing to the bonding member in at least any one of periods when the bonding tool is not landed on the bonding point during the bonding operation.

2. The wire bonding apparatus according to claim 1, wherein the heat control means and the compressed gaseous matter supply control means are configured to vary the temperature of the hot gaseous matter and the blowing timing of the hot gaseous matter for each of the bonding points.

3. The wire bonding apparatus according to claim 2, wherein the heat control means is configured to control a heat generating temperature of the heater without using a temperature sensor by controlling the value of resistance of the heater to maintain a predetermined value by electricity distribution.

4. A wire bonding method configured to connect an electrode (pad) on a semiconductor chip as a bonding point and an external terminal (lead) with a wire by a bonding tool, comprising:
a nozzle-shaped casing including a heater formed of a metal having a large coefficient of resistance temperature which can be heated instantaneously in the interior thereof, an outlet port for blowing out hot gaseous matter from a distal end thereof to a bonding member including the bonding point, and an inlet port for allowing entry of compressed gaseous matter into the other end;
heat control means configured to heat the heater; and
compressed gaseous matter supply control means configured to perform supply and block of the compressed gaseous matter into the casing, wherein
control is performed to provide a period in which the hot gaseous matter is not supplied from the casing to the bonding member by the heat control means and the compressed gaseous matter supply control means in at least any one of periods when the bonding tool is not landed on the bonding point during the bonding operation.
